(19) United States
(12) Patent Application Publication
(10) Pub. No.: US 2026/0290891 A1
(43) Pub. Date: Sep. 24, 2026

(54) BORON OXIDE-MOLTEN SALT-BASED SOLID ELECTROLYTE AND PREPARATION METHOD THEREFOR

(71) Applicant: SUKGYUNG AT CO., LTD., Ansan-si, Gyeonggi-do (KR)

(72) Inventors: Hyung Sup LIM, Ansan-si, Gyeonggi-do (KR); Young Chul YOU, Ansan-si, Gyeonggi-do (KR); Sung Hwa LEE, Siheung-si, Gyeonggi-do (KR); Jin Hee LEE, Hwaseong-si, Gyeonggi-do (KR)

(73) Assignee: SUKGYUNG AT CO., LTD., Ansan-si, Gyeonggi-do (KR)

(21) Appl. No.: 19/478,487

(22) PCT Filed: Apr. 23, 2024
(86) PCT No.: PCT/KR2024/005459

§ 371 Date: Oct. 24, 2025

(30) Foreign Application Priority Data
Apr. 25, 2023 (KR) 10-2023-0054176
Apr. 22, 2024 (KR) 10-2024-0053478

(51) Int. Cl. H01M 10/0563

(52) U.S. Cl. CPC H01M 10/0563; H01M 2300/0022

(57) ABSTRACT

Provided is, as a solid electrolyte that is a core material for an all solid state secondary battery, a solid electrolyte of a composite of lithium chloroboracite having a composition of Li₄₋ₓB₇O_{12+x/2}Cl (x=0-1) and a LiCl—LiBr—LiF molten salt. The boron oxide-molten salt-based solid electrolyte according to the present invention may resolve safety issues of P₂S₅, Li₂S, or the like that is used as a raw material for typical sulfide solid electrolytes.

### TECHNICAL FIELD

The present invention disclosed herein relates to an all solid state electrolyte for a lithium-ion battery having improved safety and ionic conductivity.

### BACKGROUND ART

Secondary batteries are batteries made up of one or more electrochemical cells that are chargeable and dischargeable. Currently, lithium-ion batteries are at the forefront, serving as an essential for small electronic devices such as smartphones. The lithium-ion batteries are superior to traditional lead-acid batteries in avoiding environmental hazards and memory effect (a phenomenon in which repeated charging of batteries during use causes discharge voltage to drop and discharge capacity to decrease below nominal capacity), and also exhibit superior energy density per unit of mass and volume.

The secondary batteries typically have a higher initial cost than disposable batteries, but are rechargeable multiple times before being replaced, thereby offering the benefit of a significantly lower total cost and environmental impact. Some types of secondary batteries are available in the same size and voltage as disposable types and are interchangeable.

However, an electrolyte (liquid or gel) inside the lithium-ion batteries poses a risk of ignition and explosion due to thermal propagation. A number of actual explosion incidents have induced growing concerns over safety.

Therefore, replacing liquid electrolytes with solid electrolytes to overcome these shortcomings offers the following benefits.
The risk of fire and explosion from temperature changes and external impacts is significantly reduced, and safety devices and separators for temperature changes and external impacts are not required, allowing for cost reduction and high capacity with the same size.
Since there is no risk of fire, a space, where a cooling device that occupies over 30% of a battery pack space is removed, is provided with additional battery cells, thereby increasing energy density.
Since there is no need for a separator that physically blocks a positive electrode and a negative electrode in the liquid electrolyte to prevent electrical short circuits, volume reduction and cost reduction are achievable.
Lithium metal, which has superior performance (including a capacity up to 10 times that of graphite), but was not used due to the risk of fire and explosion between electrodes, may be used as a negative electrode active material, enabling high capacity to be achieved with the same size.

Meanwhile, as such a solid electrolyte, a sulfide-based solid electrolyte using a Li₂S-P₂Ss-LiCl ternary raw material having an argyrodite crystal structure has been developed. However, the typical sulfide-based solid electrolyte is hazardous due to the potential generation of harmful compounds such as hydrogen sulfide (H₂S). Therefore, the need has emerged to develop a safe and mass-producible solid electrolyte capable of fundamentally eliminating the risks posed by the typical sulfide-based solid electrolyte.

### DISCLOSURE OF THE INVENTION

### Technical Problem

The present invention provides preparing a boron oxide-based solid electrolyte material in the form of particles, with high purity and ionic conductivity, and applying the boron oxide-based solid electrolyte to a lithium ion conductor for an all solid state battery.

The present invention also provides a boron oxide-based solid electrolyte material to the industry, thereby enabling economic advantages and ensuring superior safety in handling raw materials.

### Technical Solution

As one of the methods for improving the ionic conductivity of oxide-based solid electrolytes, various methods were studied to increase solid electrolyte content in the same space by increasing the density of molded bodies, such as pellets.

In accordance with an embodiment of the present invention, a solid electrolyte according to the present invention is a composite of lithium chloroboracite having a composition of Li₄₊ₓB₇O_{12+x/2}Cl (x=0-1) and a LiCl—LiBr—LiF molten salt.

Compared to before mixing, the composite mixture of lithium chloroborasite and molten salt may exhibit an increase of 20% or greater in the density of molded bodies, such as pellets, and may have a Li ion conductivity of 1.0×10−7 S/cm or greater at room temperature (25° C.).

In addition, the composite according to the present invention may be a nanoparticle having a diameter of 10 nm to 300 μm. Preferably, the particle size is 0.8 to 80 μm in diameter, and more preferably 1 to 20 μm. A smaller size may increase density and thus is preferable for ionic conductivity, but presents processing difficulties, and there are limits to increasing the density of molded bodies through particle size control. For the reasons described above, a molten salt was added to increase the density of the composite.

In accordance with another embodiment of the present invention, the composite according to the present invention is prepared by including steps of preparing lithium chloroboracite having a composition of Li₄₊ₓB₇O_{12+x/2}Cl (x=0-1), preparing a LiCl—LiBr—LiF molten salt, mixing the LiCl—LiBr—LiF molten salt with the lithium chloroborasite, pulverizing the raw material mixture, and sintering the raw material mixture at 500° C. or greater.

The composite solid electrolyte according to the present invention may resolve the issue of hydrogen sulfide generation in a moisture-containing atmosphere, caused by P₂S₅ and Li₂S, which are used as raw materials for typical sulfide solid electrolytes, and accordingly, a secondary battery manufactured to include the composite solid electrolyte may replace a secondary battery using typical liquid electrolytes and sulfide-based solid electrolytes in the market.

### Advantageous Effects

The present invention provides a solid electrolyte in the form of particles, with high purity and ionic conductivity by synthesizing a boron oxide-molten salt-based solid electrolyte.

In addition, the boron oxide-molten salt-based solid electrolyte according to the present invention may be free from safety issues such as hydrogen sulfide gas generation caused by moisture of typical sulfide solid electrolytes.

In addition, a secondary battery manufactured to include the boron oxide-molten salt-based solid electrolyte may replace a secondary battery using typical liquid electrolytes and sulfide-based solid electrolytes in the market.

### BRIEF DESCRIPTION OF THE DRAWINGS

FIG. 1 shows XRD data of lithium chloroborasite;

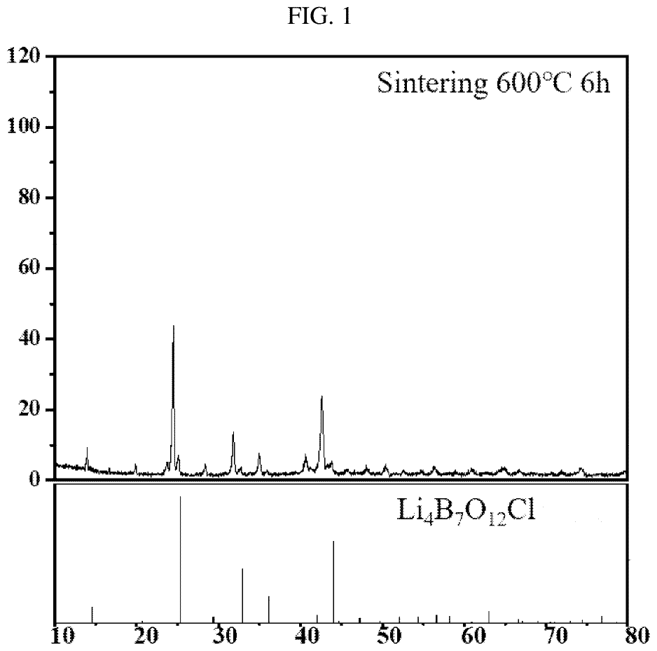

FIG. 2 is an SEM image showing lithium chloroborasite particle sizes of 2 to 40 m;

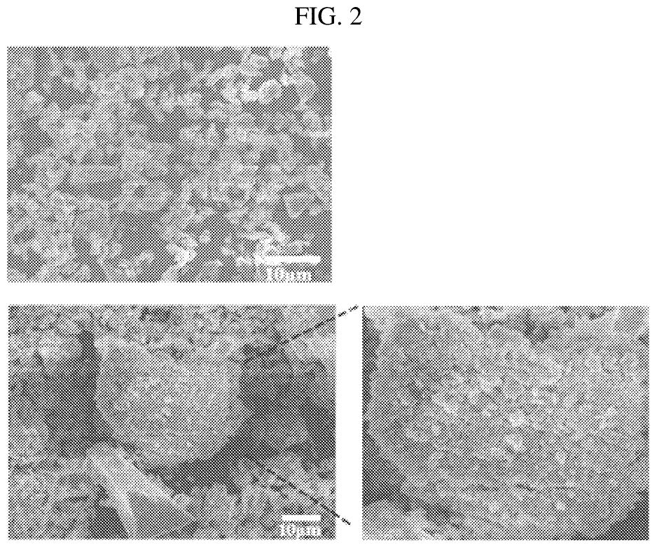

FIG. 3 shows an image of lithium chloroborasite after gold coating;

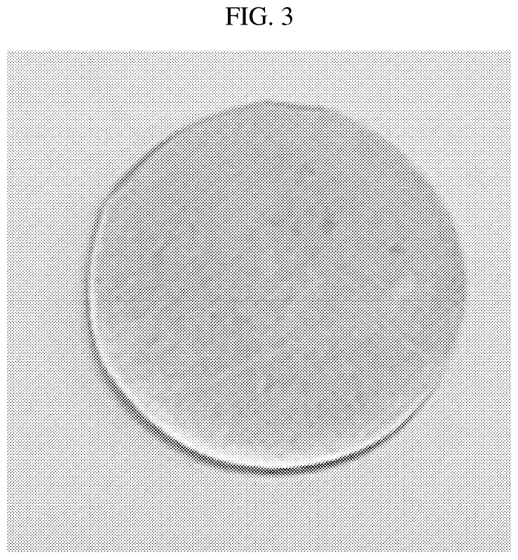

FIG. 4 is an SEM-BSE (Back Scattered Electron) image determining a coating thickness of lithium chloroborasite after gold coating in FIG. 3; and

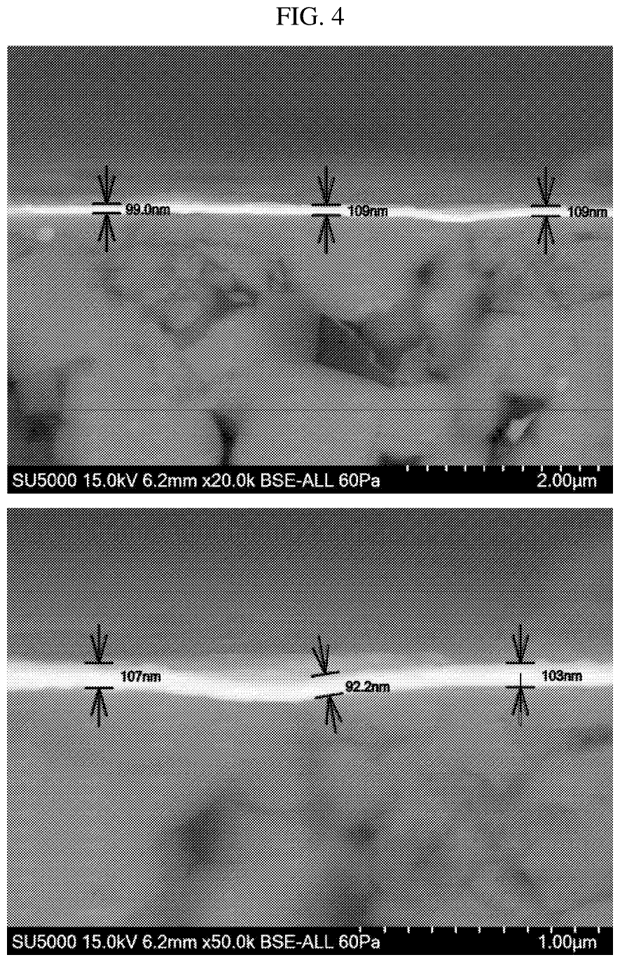

FIG. 5 shows data measuring Li ionic conductivity at room temperature after gold coating.

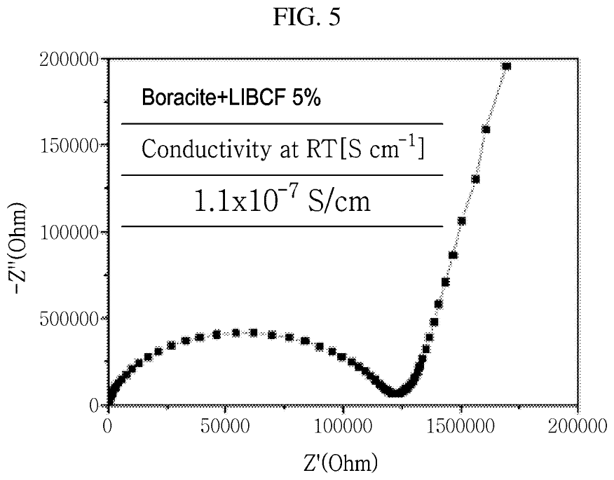

### MODE FOR CARRYING OUT THE INVENTION

Preferred embodiments of the present invention will be described below in more detail, and the description of the following embodiments is provided by way of example, but is not limited thereto.

### 1. Composition of Solid Electrolyte

In the present invention, lithium chloroborasite having a composition of Li₄₊ₓB₇O_{12+x/2}Cl (x=0-1) is prepared as LiOH or Li₂CO₃, H₃BO₃ or B₂O₃, and LiCl raw materials.

In addition, a LiCl—LiBr—LiF molten salt is prepared.

The LiCl—LiBr—LiF molten salt is mixed with the lithium chloroborasite having a composition Li₄₊ₓB₇O_{12+x/2}Cl (x=0-1), and the mixture is sintered to produce a composite of lithium chloroborasite and LiCl—LiBr—LiF molten salt.

### 2. Determination of Density and Ionic Conductivity of Molded Body

The solid electrolyte according to an embodiment of the present invention exhibited a density increase of up to 26% after sintering with respect to molded bodies compare to before mixing, and had a Li ion conductivity of 1.0×10⁻⁷ S/cm or greater as measured at room temperature (25° C.).

### —Electrical Conductivity Model/Measurement Conditions—

EIS SP-300, Scan fi=7.0 MHz, ff=1.0 Hz, Nd=10 points per decade sinus amplitude Va=20.0 mV, pw=0.10, Na=2, E Range=−10 V-10 V

### 3. Manufacture of all Solid State Secondary Battery

A positive electrode layer, a negative electrode layer, and a solid electrolyte layer are prepared using a method below, and then stacked to manufacture an all solid state secondary battery.

The solid electrolyte may be a solid electrolyte having a composition according to an embodiment of the present invention. In an embodiment, the boron oxide-based solid electrolyte is prepared by treating starting raw materials for the boron oxide-based solid electrolyte using a method such as melt-quenching or mechanical milling. In addition, additional sintering may be performed after this treatment. The additional sintering may further solidify solid electrolyte crystals.

The solid electrolyte according to an embodiment of the present invention is prepared by the following preparation method. First, the LiCl—LiBr—LiF molten salt is mixed with the lithium chloroborasite having a composition Li₄₊ₓB₇O_{12+x/2}Cl (x=0-1), and the mixture is sintered to produce a composite of lithium chloroborasite and LiCl—LiBr—LiF molten salt.

The LiCl—LiBr—LiF molten salt composite used above is also prepared by treating starting raw materials using a method such as melt-quenching or mechanical milling.

A positive electrode layer, a negative electrode layer, and a solid electrolyte layer are stacked such that the solid electrolyte layer is sandwiched between the positive electrode layer and the negative electrode layer, and then rolled to manufacture an all solid state secondary battery according to an embodiment of the present invention.

### Comparative Examples and Examples

TABLE 1

| | Comparative | Comparative | | | | | | |
|---|---|---|---|---|---|---|---|---|
| | Example 1 | Example 2 | Example 1 | Example 2 | Example 3 | Example 4 | Example 5 | Example 6 |
| Particle size (um) | 50~100 | 1~20 | 50~100 | 50~100 | 50~100 | 50~100 | 50~100 | 1~20 |
| Sintering | 550 | 550 | 550 | 550 | 550 | 550 | 550 | 550 |
| temperature (° C.) | | | | | | | | |
| Sintering time (hr) | 6 | 6 | 6 | 6 | 6 | 6 | 6 | 6 |
| Composite salt | 0 | 0 | 1% | 2% | 3% | 4% | 5% | 5% |
| mixing ratio | | | | | | | | |
| Density (g/cm³) | 1.91 | 1.95 | 1.98 | 2.15 | 2.26 | 2.27 | 2.35 | 2.43 |
| EIS(RT) | 2.0 × 10⁻⁵ | 3.0 × 10⁻³ | 3.2 × 10⁻⁸ | 5.4 × 10⁻⁸ | 6.7 × 10⁻⁶ | 7.3 × 10⁻⁸ | 8.6 × 10⁻⁸ | 1.1 × 10⁻⁷ |
| Density | — | 2.1 | 3.7 | 12.6 | 18.3 | 18.8 | 23.0 | 262 |
| increase rate (%) | | | | | | | | |

Comparative Example 1; Lithium chloroboracite
Comparative Example 2; Density improvement by pulverization
Comparative Example 1 vs. Examples 1, 2, 3, 4, and 5; Comparison by mixing ratio of composite salts
Comparative Example 2 vs. Example 6; Comparison by mixing ratio of composite salts in fine particles
Comparative Example 1 vs. Example 6; Comparison by pulverization and mixing of mixed salts

### Examples 1 to 5. Preparation of Composite Solid Electrolyte

In the present invention, lithium chloroborasite having a composition of Li₄₊ₓB₇O_{12+x/2}Cl (x=0-1) is prepared as LiOH or Li₂CO₃, H₃BO₃ or B₂O₃, and LiCi raw materials. In addition, a LiCl—LiBr—LiF molten salt is prepared.

1-5% of LiCl—LiBr—LiF molten salt is mixed with lithium chloroborasite having a composition Li₄₊ₓB₇O_{12+x/2}Cl (x=0-1), and the mixture is pelletized and sintered to produce a composite of lithium chloroborasite and LiCl—LiBr—LiF molten salt.

### Comparative Examples 1 and 2: Density and Ionic Conductivity Evaluation of Lithium Chloroboracite Solid Electrolyte

Density and ionic conductivity were measured using only lithium chloroborate sintered after synthesis using the following method. Comparative Example 1 used a solid electrolyte powder having a particle size of 50 to 100 m, and Comparative Example 2 used a powder having a particle size of 1 to 20 m and the powders were pressed (a pressure of 100 MPa/cm²) to produce pellets. The density of the produced pellets showed a tendency to increase from 1.91 g/cm³ to 1.95 g/cm³ depending on the particle size, and when Au coating was performed and the Li ionic conductivity was observed using an AC impedance measurement device at room temperature, the Li ionic conductivity was found to be slightly increased from 2.0×10⁻⁸ S/cm to 3.0×10⁻⁸ S/cm as the density increased.

### Comparative Example 1 vs. Example 6: Density and Ionic Conductivity by Pulverization and Mixing of Composite Salts

When the powder of lithium chloroboracite, pulverized to a particle size of 1 to 20 μm after synthesis and sintering, was mixed with 5% of LiCl—LiBr—LiF molten salt, the density increased by up to 26% to 2.41 g/cm³, and the Li ion conductivity was also found to be 1.0×10⁻⁷ S/cm or greater.

The boron oxide-molten salt-based solid electrolyte according to the present invention provides the following benefits.

The solid electrolyte according to the present invention provides the following benefits.
1) The solid electrolyte offer superior safety, as they have no risk of evaporation from temperature changes or liquid leakage from external impacts, do not experience swelling, and are free from explosion or ignition even under extreme external conditions such as heat and pressure.
2) Since the risk of ignition and explosion is eliminated, related components are no longer required, allowing the remaining space to be utilized for additional active material. In particular, the volume is decreased due to a reduction in the separator and PKG (current collector and cell exterior materials), and the BMS (battery management system) related to battery cooling is minimized, and accordingly, a high energy density per unit volume may be achieved.
3) Unlike liquid electrolytes, a desolvation reaction, where lithium ions are separated from a solvent, is not required. The charge/discharge reaction directly translates into the diffusion reaction of lithium ions within the solid, enabling high output.
4) Compared to typical organic electrolytes, stable performance over a wider temperature range is obtainable. High ionic conductivity is expected, particularly at low temperatures. The biggest concern for electric vehicle users is the decline in battery performance in winter, resulting in reduced driving range. When a Tesla Model X is left parked overnight in the cold at a 50% charge, the charge level drops to 30% the next morning. The adoption of all solid state batteries will resolve the issue of instability in low-temperature environments.
5) The battery structure is simple and a separator is not required. During the manufacturing process, a slurry-like solid electrolyte is applied onto a positive electrode active material. Various types of multi-layer cells may be obtained through a continuous process without the need for a liquid electrolyte injection process.

1. A solid electrolyte of a composite of lithium chloroboracite having a composition of Li₄₊ₓB₇O_{12+x/2}Cl (x=0-1) and a LiCl—LiBr—LiF molten salt.

2. The solid electrolyte of claim 1, having a Li ionic conductivity of 1.0×10⁻⁷ S/cm or greater at room temperature (25° C.).

3. The solid electrolyte of claim 1, wherein the composite is a nanoparticle having a diameter of 10 nm to 300 μm.

4. A secondary battery comprising the solid electrolyte according to claim 1.

5. A method for preparing a solid electrolyte of a composite of lithium chloroboracite and a LiCl—LiBr—LiF molten salt, the method comprising:
preparing chloroboracite having a composition of Li₄₊ₓB₇O_{12+x/2}Cl (x=0-1);
preparing a LiCl—LiBr—LiF molten salt;
mixing the LiCl—LiBr—LiF molten salt with the lithium chloroborasite;
mixing the LiCl—LiBr—LiF molten salt with the chloroborasite;
pulverizing the raw material mixture; and
sintering the raw material mixture at 500° C. or greater.

6. The method of claim 5, wherein a mixing ratio of the Li₄₊ₓB₇O_{12+x/2}Cl (x=0-1) chloroborasite and the LiCl—LiBr—LiF molten salt is 1 to 10 parts by weight for each.

7. A secondary battery comprising the solid electrolyte according to claim 2.

8. A secondary battery comprising the solid electrolyte according to claim 3.
